(19) United States
(12) Patent Application Publication
(10) Pub. No.: US 2018/0365302 A1
(43) Pub. Date: Dec. 20, 2018

(54) SYSTEM FOR INTERACTIVELY SEARCHING FOR AND DISPLAYING INFORMATION ON A WEBPAGE

(71) Applicants: Peter Yurevich TABUN, pos. Kalininets (RU); Elena Sergeevna KOLOMIETC, pos. Kalininets (RU)

(72) Inventors: Peter Yurevich TABUN, pos. Kalininets (RU); Elena Sergeevna KOLOMIETC, pos. Kalininets (RU)

(21) Appl. No.: 15/991,775

(22) Filed: May 29, 2018

Related U.S. Application Data
(63) Continuation-in-part of application No. 15/907,384, filed on Feb. 28, 2018.
Application No. 15/907,384 is a continuation-in-part of application No. 14/767,034, filed on Aug. 11, 2015, now abandoned.

(30) Foreign Application Priority Data
Jan. 20, 2011 (RU) 2011102025
Aug. 4, 2011 (EP) 11856013.5

(51) Int. Cl. G06F 17/30

(52) U.S. Cl. CPC G06F 17/30554; G06F 17/30477; G06F 17/30241; G06F 17/30867; G06F 17/3053

(57) ABSTRACT

Systems and methods for retrieving search results and displaying those search results to a user are disclosed. The systems and methods comprise employing a processing device connected to two or more databases, an operator terminal, a user communication device, and a network. The processing device receives a user inquiry of primary interest, searches the connected databases for results based on the primary inquiry, and displays the results of the inquiry. Simultaneously, the processing device searches additional databases which comprise search strategies for searches beginning with the criteria of the primary inquiry, and based on those strategies, provides a user with additional search criteria which is thematically related to a task comprising the criteria having primary interest. By suggesting additional criteria and presenting the results for that additional criteria on the same page, the user is aided in fulfilling the primary task as well as related tasks at once.

### CROSS-REFERENCE TO RELATED APPLICATIONS

This patent application is a Continuation-in-Part of U.S. patent application Ser. No. 15/907,384 filed Feb. 28, 2018 which is a Continuation-in-Part of U.S. patent application Ser. No. 14/767,034, filed Aug. 11, 2015, which claims priority to Russian Patent Application Ser. No. RU2011102025, filed Jan. 20, 2011, European Patent Application Ser. No. EP 11856013.5, filed Aug. 4, 2011, and PCT Application Ser. No. PCT/RU2011/000590, filed Aug. 4, 2011, all of which are incorporated by reference in their entireties.

### FIELD OF THE INVENTION

This invention relates to information technology, and particularly to search engines or other systems allowing to perform searches in global and/or local networks.

### BACKGROUND OF THE INVENTION

Engines or systems for searching for and displaying information, such as Google (www.google.com) or Yandex (www.yandex.ru) are widely known in the art. Such engines or systems allow the user to receive information in response to a query. Said systems are based on using server-side specialized software (so-called web crawlers) that download web pages from the network (e.g., from the internet), index (analyze) the downloaded pages, and record the indexed pages in a server-side database at specific time intervals. Then, upon receiving a query from a user terminal, the engine or system retrieves the search results from the database and outputs them to the client in the form of hyperlinks to website pages.

These engines or systems have the following disadvantages: web crawlers download and analyze all pages found in the network, which results in low search relevance in such engines or systems.

Furthermore, prior art engines or systems output the search results in such way that, in order to use the hyperlink, it is necessary to open the webpage associated therewith in a new tab or to load the webpage completely, thus navigating away from the search results page, which is inconvenient for the user and leads to increased search time.

Furthermore, it is often necessary for the user to adjust the query when, for example, the number of search results output by the system is too large or when the search results contain links to web pages having content with wording similar to that of the query but different in meaning from that of the query.

Upon adjusting the search query, the previous search results page is replaced by the page with adjusted search results. When the adjusted query is unsuccessful (e.g., no relevant pages are found), the user has to return to the previous query page (e.g., by pressing the Backspace key), which increases search time. Furthermore, if the browser cache in the user's web browser is disabled, said return causes a complete reloading of the previous page, which takes some time and leads to increased search time.

Furthermore, prior art engines or systems do not provide the technical capability for simultaneous search for topics related to the search query topic. When a user searches for information related to, for example, real estate, the user is also interested in information regarding real estate loans or mortgages, homeowner's insurance, ordering real estate design projects, construction and maintenance, supply of construction materials, ordering furniture and items of interior design, i.e., all aspects relating to household ownership.

Studies monitoring search query statistics for the internet users show that when a user performs a search with a “buy apartment” query, he or she then searches for “real estate loans and mortgages”, “interior design”, “apartment maintenance, construction firms and crews”, moving services, domestic staff, and other related terms. Therefore, this shows that the user searches for all information regarding household ownership by picking keywords and spending a great deal of time on searching and filtering through huge amounts of data. Poll results show that the internet users need to save time on searching for relevant and exhaustive information necessary to satisfy their needs, i.e., finding services provided by nearby businesses that can perform the given service in a timely manner. Therefore, it is a current problem in the art regarding how to provide all the relevant information needed by the user of the internet or other network using one web resource, how to display said information on one page, and how to allow for a search with various search criteria with the possibility of adjusting said criteria and receiving the desired information, thus significantly decreasing time and money costs.

The closest prior art for the present utility model is a system or engine for searching for information in a computer network (Russian Utility Model patent 8819 U1, 16 Dec. 1998, IPC G06F 17/30), the system comprising a server (300) comprising a device (310) for receiving and processing information which is capable of processing the received information, bringing said processed information into line with a record in memory (e.g., in a database), receiving a query from at least one user terminal (330, 331) adapted to generate search queries and displaying search results; recovering information corresponding to the search query from a database, and generating and transmitting the response to the query to the user terminal for subsequently displaying said response on the user terminal.

The prior art system has all the aforementioned disadvantages which increase time spent on searching for relevant information, thus negatively affecting the convenience of using search systems.

The present invention addressed and eliminates the aforementioned disadvantages.

### SUMMARY OF THE INVENTION

The technical effect achieved by the present invention is increased productivity resulting from reduced search time; and furthermore, the present invention provides a search system that can be used more sophisticatedly.

The aforementioned disadvantages are addressed by providing a system for interactively searching for and displaying information, the system comprising a server comprising a device for receiving and processing information which is capable of processing the received information, bringing said processed information into line with a record in a database, receiving a query for conducting a search and displaying search results; recovering information corresponding to the search query from a database, and generating and transmitting a resultant response to the query. Said device for receiving and processing information is connected with at least two databases, with the operator terminal, with the network, and with the user data communication device via corresponding interfaces, and the device is adapted to receive data from the network and/or from the operator terminal, to process at least a part of the received data in order to bring said part of the data into line with a record in the corresponding database, to carry out said recording, to receive a search query from the user data communication device, to analyze the search query, to retrieve data from at least one database in accordance with the results of search query analysis, to generate the resultant response to the search query and to transmit the resultant response to the search query to the user data communication device. The system further comprises at least one user terminal connected to the user data communication device via a communication line. Furthermore, the user terminal is adapted to generate and transmit a search query to the user data communication device via the interface provided by the user data communication device and via the user terminal browser; the user terminal is further adapted to receive the generated resultant response to the search query from the user data communication device, and to display the resultant response on the user terminal screen. The interface provided by the user data communication device is configured to provide the possibility of selecting a primary search criterion and at least one additional search criterion. Selecting an additional search criterion causes the user data communication device to command the device for receiving and processing information to perform an additional retrieval of data corresponding to the selected additional search criterion from the database and to include said data into the generated resultant response to the search query. The interface provided by the user data communication device is adapted to provide a generated resultant response to the search query, which is adapted to be displayed on the user terminal in order to display data regarding the primary and at least one additional search criteria on one browser page. The user data communication device further comprises a caching unit adapted to cache at least one generated resultant response to the search query.

An appreciation of other aims and objectives of the present invention and a more complete and comprehensive understanding of this invention may be achieved by referring to the drawings, and by studying the description of preferred and alternative embodiments.

### BRIEF DESCRIPTION OF THE DRAWINGS

The present invention will now be discussed in further detail below with reference to the accompanying figures, in which:

FIG. 1 shows search query pages of a prior art system.

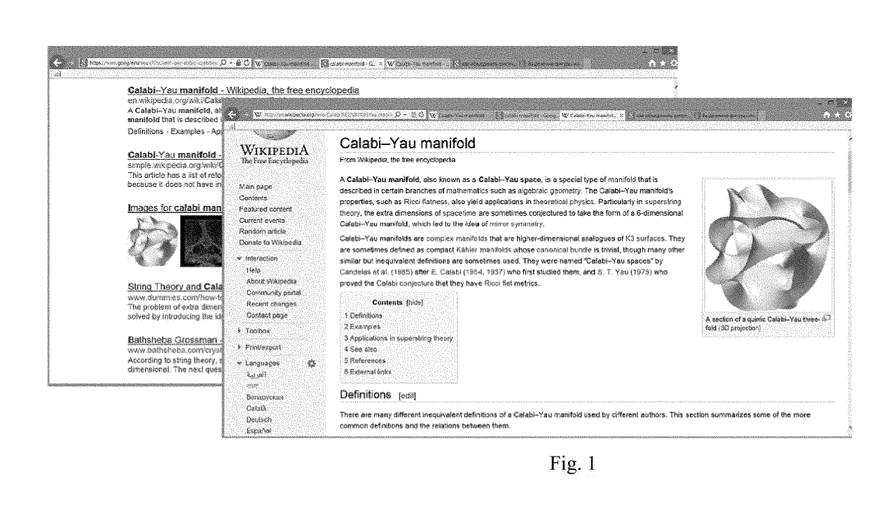

FIG. 2 shows search query pages of a prior art system which includes search results.

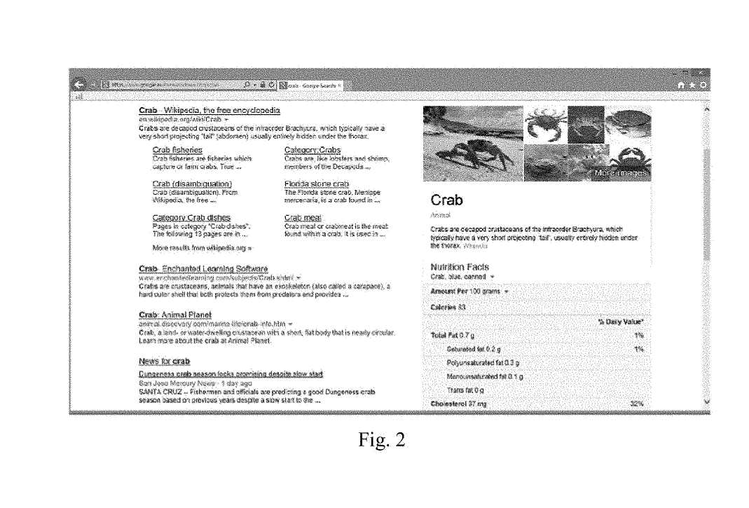

FIG. 3 shows a schematic flow chart of prior art systems.

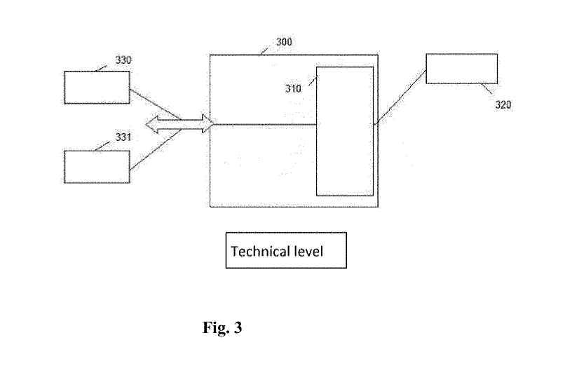

FIG. 4 shows a schematic flow chart of the present invention.

FIG. 5 shows a search page with search criteria according to the present invention.

### DETAILED DESCRIPTION OF THE PREFERRED EMBODIMENT

In the following description, for purposes of explanation, specific examples are set forth to provide a thorough understanding of the present invention. However, it will be apparent to one skilled in the art that these specific details are not required in order to practice the present invention. The same techniques can easily be applied to other types similar systems.

It will also be apparent to those skilled in the art that features disclosed below are not intended to limit the spirit and scope of the present utility model. For example, it is known that communication lines (e.g. between the user terminal and the server) can be implemented in various ways. Said lines can be wire-based lines, optic fiber lines or wireless lines. Therefore, the combination of all features is subject to patent protection as defined in the accompanying claims. The above is true for other features as well. Particularly, the user terminal can be a desktop computer, a laptop computer, a netbook, a mobile phone, a computer tablet or a similar device adapted to transmit and receive network data, and to display said data to the user.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure the term “end user” or “user” should be understood to refer to a consumer of data supplied by a data provider. By way of example, and not limitation, the term “end user” can refer to a person who receives data provided by the data provider over the Internet in a browser session, or can refer to an automated software application which receives the data and stores or processes the data.

For the purposes of this disclosure the term “metadata” and “criteria” should be understood to refer to binary data which contains content which can be of interest to an end user. By way of example, and not limitation, the term “metadata” and “criteria” can refer to multimedia data, such as video data or audio data, or any other form of data capable of being transformed into a form perceivable by an end user. Such data can, furthermore, be encoded in any manner currently known, or which can be developed in the future, for specific purposes. By way of example, and not limitation, the data can be encrypted or compressed.

For the purposes of this disclosure, a computer readable medium stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other mass storage devices, or any other medium which can be used to store the desired information and which can be accessed by the computer.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

For the purposes of this disclosure a “device” or “terminal” is a software, hardware, or firmware (or combinations thereof) system, process or functionality, or component thereof, that performs or facilitates the processes, features, and/or functions described herein (with or without human interaction or augmentation). A “device” or “terminal” can include sub-modules. Software components of a device or terminal may be stored on a computer readable medium. Devices or terminals may be integral to one or more servers, or be loaded and executed by one or more servers. One or more devices or terminals may grouped into an engine or an application.

In the main embodiment, the invention comprises an architecture of hardware elements forming a system for interactively searching for and displaying dynamic search-guiding information, said system comprising a server (400) comprising a device (410) for receiving and processing data, said device for receiving and processing information connected with at least two databases (421, 422), with the operator terminal (430), with the network (440) (e.g., the internet), and with the user data communication device (450) via corresponding interfaces, and the device is adapted to receive data from the network and/or from the operator terminal, to process at least a part of the received data in order to bring said part of the data into line with a record in the corresponding database, to carry out said recording, to receive a search query from the user data communication device, to analyze the search query, to retrieve data from at least one database in accordance with the results of search query analysis, to generate the resultant response to the search query and to transmit the resultant response to the search query to the user data communication device, wherein the system further comprises at least one user terminal (460) connected to the user data communication device via a communication line (470), said user terminal being adapted to generate and transmit a search query to the user data communication device via the interface (451) provided by the user data communication device and via the user terminal browser; the user terminal is further adapted to receive the generated resultant response to the search query from the user data communication device, and to display the resultant response on the user terminal screen, wherein the interface provided by the user data communication device is configured to provide the possibility of selecting a primary search criterion and at least one additional search criterion, wherein selecting an additional search criterion causes the user data communication device to command the device for receiving and processing information to perform an additional retrieval of data corresponding to the selected additional search criterion from the database and to include said data into the generated resultant response to the search query, wherein the interface provided by the user data communication device is adapted to provide a generated resultant response to the search query, which is adapted to be displayed on the user terminal in order to display data regarding the primary and at least one additional search criteria on one browser page, and wherein the user data communication device further comprises a caching unit (452) adapted to cache at least one generated resultant response to the search query.

The resulting display which a user sees is a dynamic combination of items. The primary search criteria results are displayed for the user. In addition, secondary search criteria are suggested to the user alongside the primary search criteria on the user display. Such secondary search criteria provide the user with suggestions for related topics of interest which are thematically related to the primary search topic or topics of interest which the specific user has (based on user profile or past search history). When a user selects one or more secondary criteria, that secondary criteria becomes either a part of the primary search terms or a second separate but visible search with results. The idea of the invention is to provide dynamic search-guiding information which comprises results as well as secondary criteria suggestions which a user may or may not have though of. Regardless of this factor, however, the user is able to continue or maneuver a search strategy to include additional but related information. This is all performed on the same webpage, with results populating the same page, and without the need for a user to perform a second (or more) additional free form searches, thus speeding up the search process.

The server may be embodied in the form of any type of computer or electronic device including software for performing the methods of the present invention as described below. The search engines may be part of the server or may operate independently from the server. The data storage devices/databases are embodied in the form of a database linked to the server. The user devices may be any type of computer and include conventional Internet browsers that can access the server via standard Internet protocols for allowing the user to input queries, review search results, and provide feedback on search results to the server.

The user can enter the search criteria by himself/herself via the interface provided by the user terminal. The system, via the device for receiving and processing information (e.g., a CPU) analyzes the history of the user's queries to identify personal preferences (for example, the preferred language of the entered terms, preferred areas of science, technology, literature, creativity, etc.), which are identified by the system from the analysis of the history of the user's requests. Additionally, the preference identification system analyzes the history of the search queries of a multitude of other users for compiling possible/probable search strategies. For example, if many users show interest in buying a car in the first query, then, after requesting a car purchase, it is possible to expect with high probability a query for obtaining a credit or loan for buying a car. These preferences can be added to the algorithms of the preferences analysis system by the system operator based on the operator's personal experience or based on the results of studying the sequences of users' search queries. The operator may add to the preference identification system a generalized task such as “buy apartment”, which can be divided into the following subtasks, which will be highly likely required by the system user, who entered into the search box “buy apartment”, in subsequent searches: “mortgage and real estate loans”, “interior design”, “apartment repair”, “moving services”, etc.

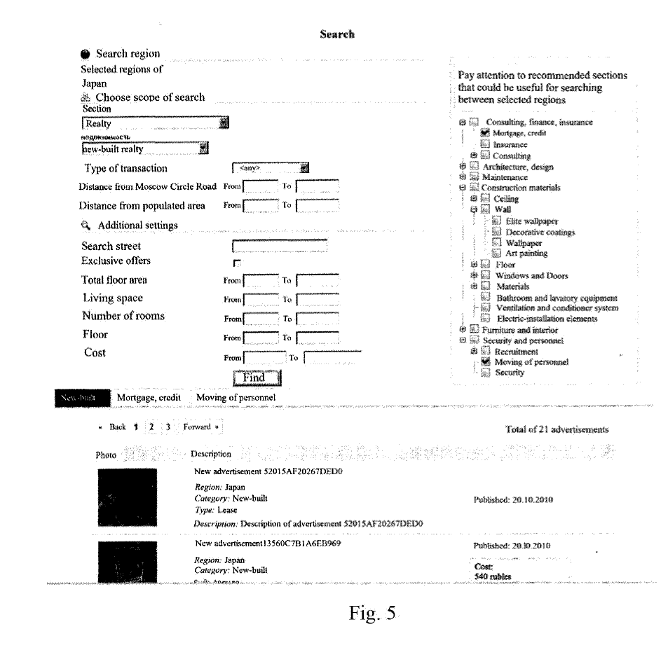

Various embodiments for displaying the options offered by the system for continuing work (i.e. additional search criteria) may be utilized, such as a “dropdown menu”, “tag cloud”, “task tree” (see FIG. 5, the category tree in the upper right part of the figure), etc.

The user enters the primary input in free form, where he/she enters the query which begins the search. The preference identification system receives the entered query and sends a list of search results, determines to which generalized task the search query relates based on a generalized task network, and in the presentation interface of the search results forms a “dropdown menu”, “tag cloud”, or “task tree” with suggested subtasks displayed for the user. When the user visually sees an option being suitable for his/her search strategy in the “dropdown menu”, “tag cloud”, or “task tree”, instead of specifying the query in the input via free form by typing using the keyboard, the user clicks (or taps on a touch screen) the corresponding menu item in the “dropdown menu”, “tag cloud”, or “task tree”.

The preference identification system automatically adds the selected option of the search continuation, i.e. the corresponding search terms are added to the input box without the user needing to manually type them (saving time for entering terms by the user and increasing the comfort of interaction with the search engine).

Each database connected to the preference identification system contains data for one thematic search area. Each database allows for in-depth vertical searching within the thematic search area corresponding to that database.

Each thematic database has a set of search strategies that are effective precisely in that thematic area. Search strategies are also stored in databases that describe the metadata of the generalized task, subtasks, etc.

Histories of search queries for each individual user and combined histories of search queries for all users of the system are stored in a third type of database. Such search query history databases are updated constantly and consistently over time, e.g., daily, hourly, weekly, etc. These databases will comprise information which helps the device for receiving and processing information determine which secondary criteria is most relevant to display to the user.

With regard to the third types of databases, assist the user transitions from one search task to an adjacent task. At the same time, many users exhibit similar behavior patterns when switching between similar vertical searches/search categories. It is when analyzing the behavior patterns of multiple users that it is possible to identify similar transitions from one list item or tree node with search metadata in one category to an adjacent element or node. In such cases, the analysis of search histories of a plurality of users is completed by forming a conditional connection of one element with metadata to another element of the linked list; one node of a tree with an adjacent node of the tree, or alternatively an adjacent node of another tree.

Each individual user also has a personalized user profile, which may be stored on a database or combination of databases. A user profile may comprise information regarding country variants, religion, general preferences, age, sex, language, interface language, all of which affects the search results to increase the relevance of the search results to the particular user. A user's personal profile is considered after/while analyzing a multitude of user search patterns, at a time when links between elements/nodes with metadata are already installed. When a specific user with a generated profile performs a search, the communication condition is compared with the user's personal profile, which allows the system to determine which next search task is highly likely to be of interest to this user. When such a conditional communication is found suitable for the profile, the user is offered an option in which not only the most probable clarifying search terms are placed, but in general form a search problem is formulated from an adjacent category into which a conditional link is formed between elements with metadata or a conditional relationship is formed between nodes of a tree.

This invention goes beyond the formation of a profile for finding the most relevant information in one category of a vertical search by forming adjacent vertical search categories as options for the user. The present invention also offers a simple transition between adjacent vertical categories. The advantage of the proposed solution is that a user is able to form links between adjacent search categories which are visible on the same page. The system offers the user, at the moment when the analysis of the user profile shows that a search task is completed or close to completion, a next related search task that is highly likely to be of interest to the user.

The method for searching can comprise various embodiments depending on the initial input of a user. In one embodiment, the method can be described using the following exemplary steps:

1. The user enters a query into the input via free form.

2. The preference identification system analyzes the terms in the query and selects the corresponding thematic search area corresponding to the query with a high degree of probability.

3.1 The system forms a first SQL query in the database of search strategies that matches the identified thematic area of the search.

3.2. The system forms a second SQL query in the history database of the particular user's search queries for specifying the user's search behavior and providing secondary criteria based on the particular user's search behavior.

3.3. The system forms a third SQL query in the history database of all users' search queries to specify search strategies that are currently in trend (for example, the popularity of spinners, which refers to a limited period of time). Therefore, when spinners are popular with many users, the result of the SQL query will cause the adjustment of the elements of the “dropdown menu”, “tag cloud”, or “task tree” interface with the subtasks to which the current element such as “spinner” is added. When the popularity of spinners decreases, users stop searching for a “spinner”, the search history of all users does not contain a “spinner”, the result of the SQL-query will cause the adjustment of the elements of the “dropdown menu”, “tag cloud”, or “task tree” with subtasks to not specify a “spinner”, although another current element may be added.

4. The system receive replies to the SQL queries, forms a list of search results, and simultaneously forms a list of elements within the “dropdown menu”, “tag cloud”, or “task tree” with subtasks that are highly likely of interest to the user in the process of implementing their search strategy.

The elements of the “dropdown menu”, “tag cloud”, or “task tree” with subtasks provide options for continuing the development of the search strategy by the user. These subtasks are highly likely to be entered by the user while deciding which direction to take for search strategy development. In this case, if the user is satisfied with or interested in one or more elements of the “dropdown menu”, “tag cloud”, or “task tree”, then he/she selects these elements. The user interface automatically adds the appropriate search terms into the input free form, adding to the search terms already present in this field. The obvious result is that the user is relieved of the need to manually enter search terms, if suitable terms are already offered by the search engine, their automatic addition shortens the input time, improves the comfort level of interaction with the search engine, and the probability of mistyping is reduced essentially to zero.

Primary criteria comprise terms specified by the user in the input via free form. If the user selects an element or elements from the “dropdown menu,” “tag cloud,” or “task tree” (i.e. secondary criteria), those terms are automatically added to the primary criteria input. Thus, these terms become a part of the search criteria as approved/selected by the user. In some cases, the user would have already thought of the secondary criteria. In other cases, a secondary criterion is one which the user did not individually think but is a useful suggestion made by the system which the user can use.

Secondary criteria, as noted above, comprise search terms which are candidate elements for related searches displayed via the “dropdown menu”, “tag cloud”, or “task tree”. Secondary criteria are defined at some level of the SQL query processing in the search engine. They are distinct from primary criteria in that they are not immediately approved by the user as corresponding strategies until they are manually chosen. At the moment when the user marks one or more secondary criteria as appropriate to his/her intentions and search strategy, that secondary criteria is converted to primary criteria and is automatically copied to the input for free form. The user may also have the option of starting a new search, e.g., via a new tab, for the secondary criteria only, thus keeping the search results for primary and secondary criteria separate.

The user interface may comprise various embodiments. However, in general, the user interface is divided into 3 separate areas:

(1) The input for free form (not shown in FIG. 5) is where the user begins by manually typing the primary criteria to begin a search.

(2) The elements of the “dropdown menu”, “tag cloud”, or “task tree” contains suggestions from the system (see FIG. 5, upper half) for developing the user's search strategy. These elements comprise secondary criteria, retrieved from one or more thematic databases, which are highly likely of interest to the user in the process of implementing the search strategy, as well as solving the search task.

(3) The search results area (see FIG. 5, bottom half) contains the main array of information that the user studies in order to complete the search task. Search results may be separated by tabs, folders, windows, etc. but are always accessible on the same webpage.

Method for Using the Search System.

When a user accesses the search engine, the search task begins.

The user commits volitional actions and formulates primary criteria. The search engine, taking into account already indexed pages, taking into account current trends, taking into account personal preferences, etc., generates additional terms and concepts—i.e., secondary criteria (additional search criteria)—which have a high degree of probability to be of interest to the user as relating to that search strategy and solving the user's entire search task.

The search results are displayed at the bottom of the user interface, as shown in FIG. 5. There, two results are indicated. The results can be separated by tabulation, increased line spacing, or cell boundaries in a table with columns and rows. Depending on the thematic area of the search, one option of separating the results may be chosen based on a preference of either the user or the thematic search area. For example, when searching for images, it is preferable to place the resulting images in cells of a table with several columns and several rows. In addition, if the user selects one of the images in the search sample, the selected image can be zoomed in for a more convenient study by the user.

The user terminal (461) sends queries to the search engine (400), and the search engine in turn sends SQL queries to the databases (423).

One user terminal requires as few as one database, however more databases allow for broader searching ability. One user terminal thus is able to provide the user with a better searching service using more databases. It is enough for one user terminal to be connected to one working usual database of web page indices on the Internet. The user is able to obtain a solution to the search task that is of interest to the user by means of this database and the search engine. However, the connection of additional databases provides a shortening of the time that is necessary to solve the user's search task and increases the user's comfort level of working with the search engine.

The user studies at each stage the search results area and concludes at a final iteration that the search is completed, due to the user finding all that he/she needed to find. At this point, the search task is completed.

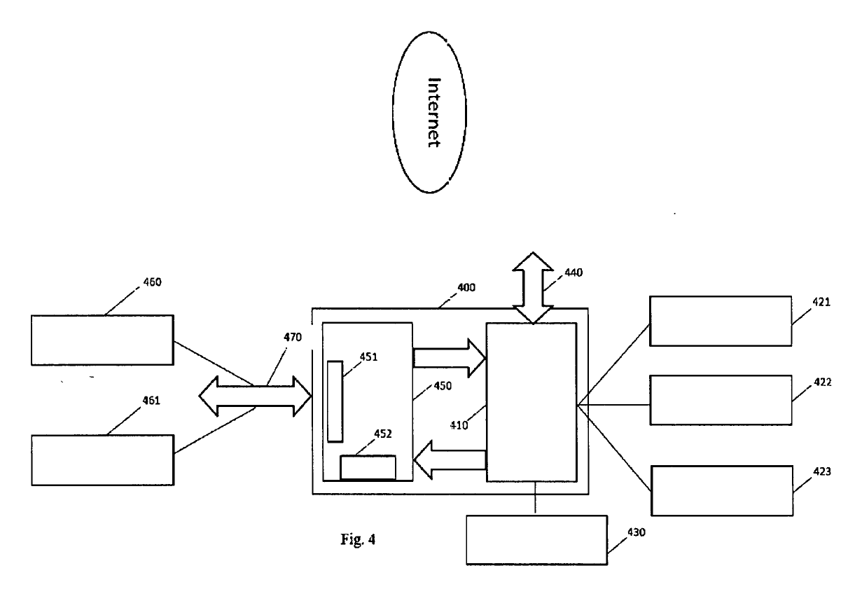

FIG. 4 further shows the architecture of an embodiment with more than one user terminal (461) and more than two databases (423). Furthermore, it is apparent that the communication line between the user terminal and the server can be the Internet.

The system is operated as follows. The user accesses the server via the user terminal as described above. The user terminal comprises software (e.g., a browser) which allows the user to operate the server-side interface. FIG. 5 illustrates the selection of the primary search criterion (direction) by the user taking into account the geographical region of the user, wherein the user is provided with an option of selecting additional search criteria thematically linked to the primary criterion. Furthermore, the user can narrow the search for both the primary and the additional criteria using several sublevels (in this instance, by means of a tree structure). As shown in FIG. 5, the search results for both the primary and the additional criteria are displayed in the same window used for selecting search criteria. Particularly, a window frame with tabs can be used, wherein upon activating said tabs, a generated response for the corresponding criterion is displayed. Due to the possibility of caching the search query response, the user does not have to refresh the page in order to return to previous search results, which significantly decreases search time and therefore allows for more convenient search engine operation.

Since the additional search criteria are linked to the primary criterion, the search time is also reduced. FIG. 5 shows a user interface example where the user searches for newly-built real estate property in Japan. The selected additional criteria are “real estate loans, mortgage” and “moving services”. In this case, the user will receive data from databases corresponding to the selected criteria. When a corresponding tab in the window frame is activated, said data will be displayed for viewing. The “real estate loans, mortgage” tab provides information regarding companies providing mortgage for the newly-built real estate property in Japan.

FIG. 5 shows an interface where the user's interest is in buying real estate in Japan. In the embodiment shown in FIG. 5, the actual location of the user does affect the search results (i.e., the automatic location determining function is turned off).

In another embodiment, the location of the user can be determined and analyzed by the system for the convenience of working with the search engine, as well as to reduce the time that the user will have to spend on solving the search task. For example, the automatic location determining function of a user by his/her IP address may indicate in which language it is preferable to represent the user interface (however, personal user interface language settings are first taken into account by the system).

In another embodiment, the automatic location-determining function can be used to determine the preferred currency that is available to the user, and if the item that is of interest to the user is put on the market in a different currency, the user will highly likely need a currency converter as well as a currency exchange service. Appropriate additional criteria comprising currency converters and currency exchange services near the user (or near the item) can be offered to the user for study. Since such a subtask can be postponed by the user to a later period, the preferred embodiment may include opening an additional window or an additional tab in the background. In another embodiment, a corresponding record can be made in the user profile database or the search history database, which, if the user enters the term “currency exchange” into the input free form, the search engine will offer converter and exchange of currency options based on the user's location, the user's currency, and also corresponding to the currency used within the location of the item).

The user deliberately chooses secondary criteria and converts specific secondary criteria to primary criteria. Any primary criteria which becomes of no interest to the user can be removed by deleting the relevant search criteria from the free form input.

Activation of secondary criteria is performed by selecting the checkbox followed by a check mark in the checkbox (see FIG. 5, the activated elements are marked with a check mark, if there is no check mark next to the element, it is not activated).

In an alternative embodiment, the elements of a “dropdown menu”, “tag cloud”, or “task tree” interface may also contain secondary elements for similar activation.

The following is a list of potential databases used by the system of the present invention:

1. Search strategies database, which corresponds to the identified thematic search area.

2. History databases comprising search queries for each individual user, employed by the system for specifying the user's specific search behavior.

3. History database comprising search queries for all users, employed by the system for specifying current search strategies that are currently in trend.

4. Other databases: such as a database of IP-geolocation, a database of interface languages which are preferable for the user, a database of the preferred currencies of countries having a corresponding geolocation, and others databases.

Filling the databases by means of an operator terminal allows for the system to filter out undesired content and to record verified data in the database, which allows the user to avoid browsing “junk” data, reduces search time, and allows for more convenient and efficient search engine operation.

The caching device can be a data storage device adapted to record and read data, said device controlled by the data communication device and connected to the user data communication device using memory device connection methods known in the art.

Furthermore, the engine or system for searching for information disclosed herein does not preclude use of traditional methods of displaying information. For example, the present engine or system can include means for ranking data displayed when the resultant response to the search query is generated. Said data ranking can be based on methods for data ranking widely used in the art in order to further increase the relevance of search results displayed on the user screen.

The search results ranking takes into account the personal preferences of a particular user in order that the search results, which highly likely contain the search task solution for this particular user, is in the first lines of the search engine results page.

The present invention forms information structures that are stored in and continuously added/removed to/from a database. Such structures can be implemented in the form of a linked list or tree. At the same time, the metadata for the successful solution of the search problem, popular among users, in one vertical, thematic category is stored in the list element or tree node. At the same time, the link of the list element to the neighboring element, the link of the tree branch with the neighboring node, simultaneously characterizes the transition condition for this connection and the transition through such a connection leads respectively to another list item or node of the tree in which the metadata is saved to successfully solve another search problem with which the user accesses the search engine. These metadata successfully solve the search problem in another category of a vertical search. For example, the first metadata is associated with a vertical search in the home purchase category. Subsequent metadata are associated with the resolution of the issue of repair, or with the resolution of the issue of mortgage lending, a related category within the vertical search.

The technical result of the invention consists in reducing the average time for solving a set of search problems consisting of several subtasks. When one task is completed, the user is prompted to move to the adjacent category of a vertical search. Reducing the time for solving the complex search problem is provided by automatically generating prompts for the transition to an adjacent category of the vertical search.

It is noted that in the present invention, the server may be any suitable type of server utilizing known search engine technology as recognized by one skilled in the art, including the receipt of a user request, processing the request and generating search result operations. The processing device may be any suitable type of processing device operative to perform processing operations as described in further detail below. Any storage device may be a computer readable medium or any suitable type of physical device capable of having the executable instructions stored thereon, for example the storage device may be internal memory within a computing system, or in another example the storage device may be an optical disc having the instructions stored thereon. It is recognized that the examples of internal memory and an optical disc are exemplary in nature and are not limiting as to any storage device.

It is further noted that the databases may be any number of data storage devices having search information stored thereon, such as for example information about web-based content (e.g. URLs and a description) and profile information to be placed in a search results page. The network may be any suitable type of networking interconnection allowing for networked communication, e.g. the Internet. The output display/user interface may be any suitable type of remote or networked processing device and is not limited to the illustrated computer, but may also include any mobile device, and more generally relates to any processing device operative to communicate with the search system via a networked connection, e.g. the network.

It is further noted that any query analysis engine may be operative to examine input received from the user. Profile analysis engines may be operative to analyze information associated with one or more user profiles. Data collection engines may be operative to create, track, maintain and collect profiles as well as information associated with a user profile, a search profile, and a query profile.

The present invention regards systems and methods for executing functions by the system, comprising:

A system for interactively searching for and displaying information, said system comprising: a server comprising a device for receiving and processing data, said device for receiving and processing data being connected with at least two databases, an operator terminal, a network, and with a user data communication device, said device for receiving and processing data being configured to: (1) receive data from the network and data from the operator terminal, (2) process the received data in order to correlate said data with a record in a corresponding database, (3) receive a search query from the user data communication device, (4) retrieve data from at least one of the at least two databases based on a search query analysis, (5) generate a first response to the search query, and (6) transmit the first response to the search query to the user data communication device, wherein the system further comprises: at least one user terminal connected to the user data communication device via a communication line, said user terminal being configured to generate and transmit a search query to the user data communication device, the user terminal being further configured to receive the response to the search query from the user data communication device, and to display the response on a screen, wherein a user interface connected to the user data communication device is configured to provide an option for selecting a primary search criterion via a free form input and an option for selecting at least one additional search criterion via a list of additional search criteria, said at least one additional search criterion being thematically related to said primary search criterion, wherein a selecting of at least one additional search criterion causes the device for receiving and processing information to perform an additional retrieval of data corresponding to the selected at least one additional search criterion from a database connected to the device for receiving and processing information, wherein the user interface is configured to provide a dynamic search-guiding second response to the search query on a same browser page as said first response, said second response comprising data regarding the at least one additional search criteria, and wherein the user data communication device further comprises a caching unit configured to cache at least one generated response to the search query.

In some aspects, a primary search criterion is selected via free form input by a user into a primary search box.

In some aspects, a selecting of at least one additional search criterion causes that at least one additional search criterion to be added to the free form primary search box.

In some aspects, each database is configured for vertical searching.

In some aspects, the device for receiving and processing information is further connected with at least one search strategy database, said at least one search strategy database comprising generalized tasks and related subtasks, and wherein the device for receiving and processing information is configured to search said at least one search strategy database for suggested additional search criteria to be displayed on the user interface.

In some aspects, the device for receiving and processing information is further connected with at least one search query history database, each search query history database comprising histories of search queries for individual users and combined histories of search queries for groups of users, wherein the device for receiving and processing information is configured to search the at least one search query history database to determine, based on the primary search criterion, additional search criteria to be displayed on the user interface.

In some aspects, the at least one search query history database is updated consistently over time.

In some aspects, the device for receiving and processing information performs SQL queries to retrieve data from at least one of the two or more databases.

In some aspects, each database is a thematic database.

In some aspects, the additional search criteria are displayed in a dropdown menu.

In some aspects, the additional search criteria are displayed in a tag cloud.

In some aspects, the additional search criteria are displayed in a task tree.

In some aspects, said first response, said second response, said free form input, and said list of additional search criteria are available on one browser page.

In some aspects, the device for receiving and processing information is further configured to account for a user's geographical location via GPS, such that the additional search criteria generated relates to said geographical location.

In some aspects, search results comprising said first and second responses are provided to a user in a language native to said geographical location.

In some aspects, results comprising said first and second responses are provided to a user in a currency related to said geographical location.

In some aspects, the operator terminal is configured to filter undesired content from the first and second responses.

In some aspects, the device for receiving and processing information is further connected to a user profile database containing custom user preferences.

In some aspects, information from said user profile database is used to rank search results.

In some aspects, information from said user profile database is used to control user interface display options.

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A system for interactively searching for and displaying information, said system comprising:
a server comprising a device for receiving and processing data,
said device for receiving and processing data being connected with at least two databases, an operator terminal, a network, and with a user data communication device,
said device for receiving and processing data being configured to:
receive data from the network and data from the operator terminal,
process the received data in order to correlate said data with a record in a corresponding database,
receive a search query from the user data communication device,
retrieve data from at least one of the at least two databases based on a search query analysis,
generate a first response to the search query, and
transmit the first response to the search query to the user data communication device,
wherein the system further comprises:
at least one user terminal connected to the user data communication device via a communication line, said user terminal being configured to generate and transmit a search query to the user data communication device,
the user terminal being further configured to receive the response to the search query from the user data communication device, and to display the response on a screen,
wherein a user interface connected to the user data communication device is configured to provide an option for selecting a primary search criterion via a free form input and an option for selecting at least one additional search criterion via a list of additional search criteria, said at least one additional search criterion being thematically related to said primary search criterion,
wherein a selecting of at least one additional search criterion causes the device for receiving and processing information to perform an additional retrieval of data corresponding to the selected at least one additional search criterion from a database connected to the device for receiving and processing information,
wherein the user interface is configured to provide a dynamic search-guiding second response to the search query on a same browser page as said first response, said second response comprising data regarding the at least one additional search criteria, and
wherein the user data communication device further comprises a caching unit configured to cache at least one generated response to the search query.

2. The system of claim 1, wherein a primary search criterion is selected via free form input by a user into a primary search box.

3. The system of claim 2, wherein a selecting of at least one additional search criterion causes that at least one additional search criterion to be added to the free form primary search box.

4. The system of claim 1, wherein each database is configured for vertical searching.

5. The system of claim 1, wherein the device for receiving and processing information is further connected with at least one search strategy database, said at least one search strategy database comprising generalized tasks and related subtasks, and wherein the device for receiving and processing information is configured to search said at least one search strategy database for suggested additional search criteria to be displayed on the user interface.

6. The system of claim 1, wherein the device for receiving and processing information is further connected with at least one search query history database, each search query history database comprising histories of search queries for individual users and combined histories of search queries for groups of users, wherein the device for receiving and processing information is configured to search the at least one search query history database to determine, based on the primary search criterion, additional search criteria to be displayed on the user interface.

7. The system of claim 6, wherein the at least one search query history database is updated consistently over time.

8. The system of claim 1, wherein the device for receiving and processing information performs SQL queries to retrieve data from at least one of the two or more databases.

9. The system of claim 1, wherein each database is a thematic database.

10. The system of claim 1, wherein the additional search criteria are displayed in a dropdown menu.

11. The system of claim 1, wherein the additional search criteria are displayed in a tag cloud.

12. The system of claim 1, wherein the additional search criteria are displayed in a task tree.

13. The system of claim 1, wherein said first response, said second response, said free form input, and said list of additional search criteria are available on one browser page.

14. The system of claim 1, wherein the device for receiving and processing information is further configured to account for a user's geographical location via GPS, such that the additional search criteria generated relates to said geographical location.

15. The system of claim 14, wherein results comprising said first and second responses are provided to a user in a language native to said geographical location.

16. The system of claim 14, wherein results comprising said first and second responses are provided to a user in a currency related to said geographical location.

17. The system of claim 1, wherein the operator terminal is configured to filter undesired content from the first and second responses.

18. The system of claim 1, wherein the device for receiving and processing information is further connected to a user profile database containing custom user preferences.

19. The system of claim 18, wherein information from said user profile database is used to rank search results.

20. The system of claim 18, wherein information from said user profile database is used to control user interface display options.
